(19) United States
(12) Patent Application Publication
(10) Pub. No.: US 2019/0276982 A1
(43) Pub. Date: Sep. 12, 2019

(54) ROPE STRUCTURES, SYSTEMS, AND METHODS INCORPORATING RFID TRANSMITTERS

(71) Applicant: Samson Rope Technologies, Ferndale, WA (US)

(72) Inventor: James R. Plaia, Ferndale, WA (US)

(21) Appl. No.: 16/294,454

(22) Filed: Mar. 6, 2019

Related U.S. Application Data
(60) Provisional application No. 62/639,410, filed on Mar. 6, 2018.

(51) Int. Cl. D07B 1/14; G01L 1/00; G06K 7/00; G06K 7/10

(52) U.S. Cl. CPC D07B 1/148; G06K 7/10366; G06K 7/0008; G01L 1/005

(57) ABSTRACT

An RFID rope structure comprises an RFID thread and a plurality of rope elements. The RFID thread comprises a carrying structure and a plurality of RFID systems supported by the carrying structure. The plurality of rope elements are combined to define a reference axis. The RFID thread is supported by the rope elements such that each of the RFID systems is arranged at a predetermined location along the rope reference axis.

### RELATED APPLICATIONS

This application (Attorney's Ref. No. P219620) claims benefit of U.S. Provisional Application Ser. No. 62/639,410 filed Mar. 6, 2018, the contents of which are incorporated herein by reference.

### TECHNICAL FIELD

The present invention relates to rope systems and methods and, more specifically, to rope systems and methods incorporating RFID transmitters.

### BACKGROUND

Rope structures are often used to transmit loads between two or more objects. A rope structure typically exhibits a number of operational characteristics determined by factors such as size of the rope structure, material or materials from which the rope structure is fabricated, and construction of the rope. Further, when transmitting loads, rope structures are typically subjected to load conditions by being placed under tensions, engaging objects, and being subjected to a wide range of environmental conditions such as sun, water, and/or temperature.

Under normal use, the operational characteristics of a rope structure typically changes over time. For example, a newly manufactured rope structure may have one set of operational characteristics, while that same rope structure may have a second set of operational characteristics after a “break-in” period. As another example, a rope structure that has been placed under tension loads, submerged in salt water, and exposed to the sun may have different operational characteristics from that same rope structure when originally broken in.

The need thus exists for systems and methods for monitoring the operational characteristics of a rope structure to determine whether the rope meets certain predefined minimum operational characteristics.

### SUMMARY

The present invention may be embodied as an RFID rope structure comprises an RFID thread and a plurality of rope elements. The RFID thread comprises a carrying structure and a plurality of RFID systems supported by the carrying structure. The plurality of rope elements are combined to define a reference axis. The RFID thread is supported by the rope elements such that each of the RFID systems is arranged at a predetermined location along the rope reference axis.

The present invention may also be embodied as a rope system comprising an RFID rope structure, an RFID reader, and a processor. The RFID rope structure comprises an RFID thread and a plurality of rope elements. The RFID reader is arranged at a desired location relative to the RFID rope structure. The processor determines at least one characteristic of the RFID rope structure as at least a portion of the RFID rope structure moves past the RFID reader.

The present invention may also be embodied as an RFID rope structure comprising an RFID thread and a plurality of rope strands. The RFID thread comprises a carrying structure and a plurality of RFID systems supported by the carrying structure. The plurality of rope strands are combined to define a reference axis. The RFID thread is supported by at least one of the rope strands such that each of the RFID systems is arranged at a predetermined location along the rope reference axis.

### DESCRIPTION OF THE DRAWING

FIG. 1 is an elevation view of a portion of a first example RFID thread of the present invention;

FIG. 2 is an elevation view of the first example RFID thread illustrating the spacing between RFID components thereof;

FIG. 3 is an elevation view of a rope structure or system incorporating an RFID thread such as the first example RFID thread depicted in FIGS. 1 and 2;

FIG. 4 is a section view taken along lines 4-4 in FIG. 3;

FIG. 5 is a section view depicting a second example RFID thread of the present invention;

FIG. 6 is a section view depicting a third example RFID thread of the present invention;

FIG. 7 is a section view depicting a first example system for manufacturing second and third example RFID threads of the present invention;

FIG. 8 is a section view depicting a fourth example RFID thread of the present invention;

FIGS. 9 and 10 are section views depicting a second example system for manufacturing the fourth example RFID thread of the present invention;

FIG. 11 is a section view depicting a fifth example RFID thread of the present invention;

FIG. 12 is a section view depicting a third example system for manufacturing the fifth example RFID thread of the present invention;

FIG. 13 is a section view depicting a sixth example RFID thread of the present invention;

FIGS. 14 and 15 are section views depicting a fourth example system for manufacturing the sixth example RFID thread of the present invention;

FIG. 16 is a section view depicting a seventh example RFID thread of the present invention;

FIG. 17 is a section view depicting an eighth example RFID thread of the present invention;

FIG. 18 is a section view depicting a ninth example RFID thread of the present invention;

FIG. 19 is a section view showing a system for fabricating a tenth example RFID thread of the present invention;

FIG. 20 is somewhat schematic block diagram illustrating vessel mounted a rope monitoring system that may be used in conjunction with or incorporate a rope structure including any of the RFID threads described above;

FIG. 21 is somewhat schematic block diagram illustrating a rope monitoring system that may be used in conjunction with or incorporate a rope structure including any of the RFID threads described above to provide feedback to a user rappelling from a structure such as a helicopter; and

FIG. 22 is a section view depicting a tenth example RFID thread of the present invention.

### DETAILED DESCRIPTION

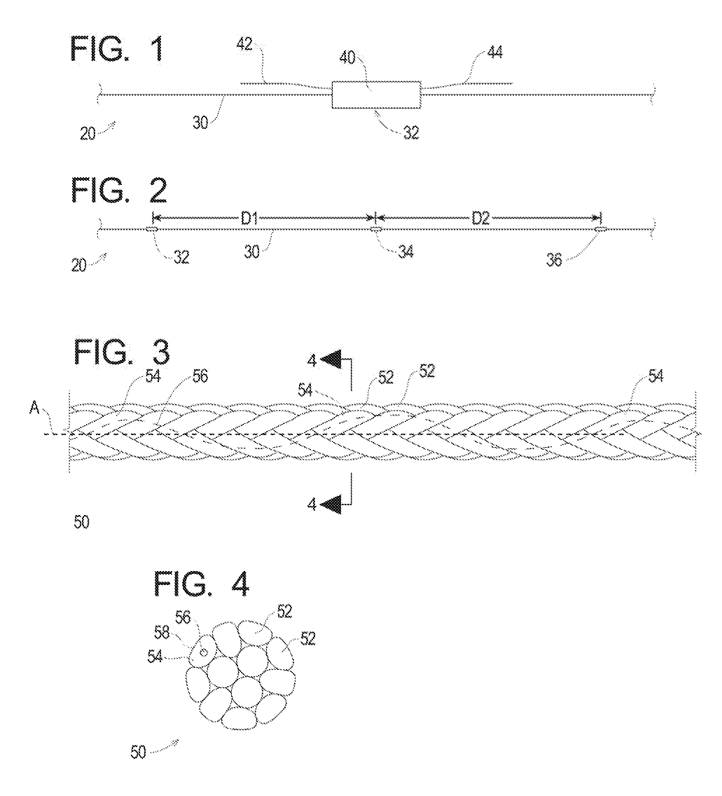

Referring initially to FIGS. 1 and 2 of the drawing, depicted therein is a first example RFID thread 20 constructed in accordance with, and embodying, the principles of the present invention. FIG. 2 illustrates that the portion of the first example RFID thread 20 depicted therein comprises a carrying structure 30 and at least first, second, and third RFID systems 32, 34, and 36. Typically, an RFID thread of the present invention will comprise more than three RFID systems such as the example RFID systems 32, 34, and 36, but, for clarity and simplicity, only the three RFID systems 32, 34, and 36 are depicted in FIG. 2 and only the example first RFID system 32 is depicted in FIG. 1.

The example carrying structure 30 is continuous filament or yarn structure formed by a plurality of filaments. The example carrying structure 30 is configured to support to each of the RFID systems 32, 34, and 36 at desired locations along the length of the RFID thread 20. In the example depicted in FIG. 2, the RFID systems 32 and 34 are supported a distance D1 from each other, while the RFID systems 34 and 36 are supported a distance D2 from each other. The distances D1 and D2 may be the same as depicted in FIG. 2 or may be different.

FIG. 1 illustrates that the example RFID system 32 depicted therein comprises a chip structure 40 and first and second antennas 42 and 44 extending from the chip structure 40. The example chip structure 40 is secured to the carrying structure 30 such that the example first and second antennas 42 and 44 extend from the chip structure 40 in opposite directions such that the first and second antennas 42 and 44 are substantially parallel to the portions of the carrying structure 30 adjacent to the chip structure 40.

In the first example RFID thread 20, the example RFID systems 34 and 36 are the same as the example RFID system 32. However, different types of RFID systems may be used to form one or more of the example RFID systems 32, 34, and 36.

In addition, the RFID systems 32, 34, and 36 may each be preconfigured to store data or may be programmed during manufacture or in the field to store or update data. The data stored on the RFID systems 32, 34, and 36 may be the same. Typically, however, the data stored on the example RFID systems 32, 34, and 36 typically comprise first and second data units. The first data unit may be associated with the particular environment or rope structure in which the first example RFID thread 20 is used, while the second data unit may be associated with an order and/or location of each of the individual RFID systems 32, 34, and 36 along the length of the first example RFID thread 20.

Referring now to FIGS. 3 and 4, depicted therein is an example RFID rope structure 50 containing the first example RFID thread 20. The example rope structure 50 is a twelve-strand braided rope and defines a reference axis A. The reference axis A generally extends along the length of the rope structure 50 but need not be linear.

The example rope structure 50 comprises eleven of first strands 52 and one second strand 54. The example first strands 52 are or may be conventional and typically comprises a combination of a plurality of yarns, which each yarn formed by a plurality of filaments or fibers. The example second strand 54 comprises a combination of a plurality of yarns each formed by a plurality of filaments or fibers but further contains an RFID element 56. The example RFID element 56 may be formed by an RFID thread such as the first example RFID thread 20 described above. The yarns forming the strands 52 and 54 and the filaments or fibers forming those yarns are not depicted in FIGS. 3 and 4 for purposes of clarity.

As shown in FIG. 4, the example second strand 54 is formed such that the example RFID element 56 lies within an outer perimeter 58 of the second strand 54; the example RFID element 56 is thus substantially surrounded by the yarns forming the second strand 54. FIG. 3 illustrates that the strands 52 and 54 are combined to form the rope structure 50 such that each of the strands 52 and 54, and thus the example RFID element 56 forming part of the second strand 54, follows a non-linear path relative to the reference axis A defined by the rope structure 50. In particular, the example RFID element 56, when used as part of the example rope structure 50, follows a somewhat helical path that extends around at least a portion of the reference axis A. Accordingly, a thread length LT of the RFID element 56 before being used to form the example rope structure 20 is longer than a rope length LR of the rope structure 50 itself.

If the first example RFID thread 20 is used as the RFID element 56, the RFID systems 32, 34, and 36 will be arranged within the second yarn 54. Further, the first example RFID thread 20 may, and typically will, comprise more than three RFID systems such as the example RFID systems 32, 34, and 36.

### The RFID Systems

Further, the distances D1 and D2 defined by the first example RFID thread 20 as described above are the same, and the distances between any two adjacent RFID systems forming the first example RFID thread 20 will also be the same as D1 and D2. In this case, the RFID systems forming a part of the example rope structure 50 will be substantially evenly spaced along the rope length LR.

As described above, each of the RFID systems may be configured to store data. In the context of the RFID thread 20 used to form the RFID element 56, the data stored by the RFID systems 30, 32, and 34 may comprise first and second data units as described above. The first data unit may be a number representing a particular piece of rope, while the second data unit may be a number representing relative position of a particular RFID system along the length of that particular piece of rope. In that example, the identity of the particular piece of rope and the approximate reading position along the length of the particular piece of rope may be determined by reading data stored by a particular RFID system located at or adjacent to the reading position.

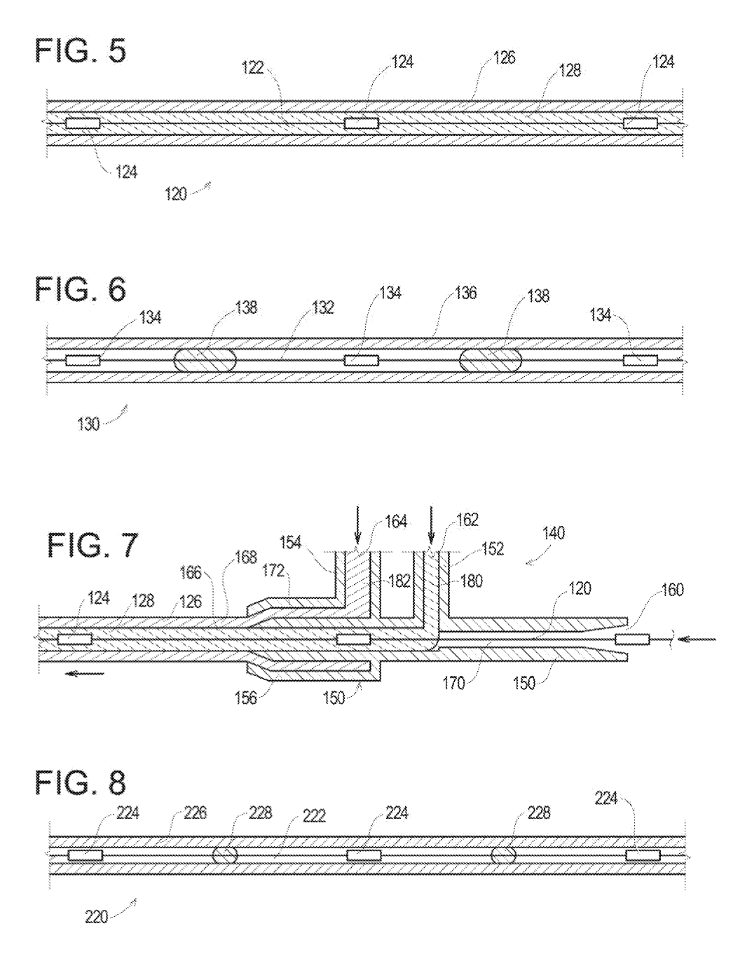

Turning now to FIG. 5, a second example RFID thread 120 is depicted therein. The second example RFID thread 120 comprises a carrying structure 122, a plurality of RFID systems 124, a jacket structure 126, and a spacer portion 128. The example RFID thread 120 may be used as part of an RFID rope structure such as the RFID rope structure 50.

The example carrying structure 122 supports the example RFID systems 124 at spaced intervals. The example carrying structure 122 primarily facilitates the handling of the RFID systems 124 during subsequent processing of the RFID thread as will be described below. The example carrying structure 122 typically does not significantly affect the structural properties of any rope structure incorporating the second example RFID thread 120.

In the second example RFID thread, the intervals between adjacent RFID systems 124 are constant, but these intervals can be varied. The RFID systems 124 may all be the same, or one or more types of RFID systems may be used to form the second example RFID thread 120. As an example embodiment of the second example RFID thread 120 including different spacing intervals between and different types of RFID systems, a first type of RFID system 124 may be located at each end of the RFID thread 120, and a second type of RFID system may be arranged at equally spaced intervals between the ends of the RFID thread 120.

The example jacket structure 126 is a continuous member that extends along at least a portion of the length of the second example RFID thread 120 and at least partly encloses the carrying structure 122 and RFID systems 124. The example jacket structure 126 may take a variety of forms, but typically will be made of material configured to protect one or both of the carrying structure 122 and the RFID systems 124. As examples, the example jacket structure 126 may enhance resistance to abrasion of the carrying structure 122 and/or RFID systems 124 and may prevent or inhibit water from reaching the RFID systems 124.

The example spacer portion 128 is arranged outside of the carrying structure 122 and RFID systems 124 and inside of an annular jacket chamber defined by the jacket structure 126 and extends the entire length of the second example RFID thread 120. The example spacer portion 128 may take a variety of forms, but typically will be made of material selected and configured to engage the jacket structure to form a seal within the jacket chamber and around one or both of the carrying structure 122 and the RFID systems 124. With appropriate selection of the materials forming the jacket structure 126 and the spacer portion 128, water may be prevented from reaching one or both of the carrying structure 122 and the RFID systems 124. The RFID systems 124 in particular may not operate properly when submersed in water. For example, if the example RFID system 32 depicted in FIG. 1 is used as the RFID systems 124, water may contact the first and second antennas 42 and 44 and prevent proper operation of the example RFID system 32.

FIG. 6 illustrates a third example RFID thread 130. The third example RFID thread 130 comprises a carrying structure 132, a plurality of RFID systems 134, a jacket structure 136, and a plurality of discrete spacer portions 138. The third example RFID thread 130 may be used as part of an RFID rope structure such as the RFID rope structure 50.

The example carrying structure 132 supports the example RFID systems 134 at spaced intervals. The example carrying structure 132 primarily facilitates the handling of the RFID systems 134 during subsequent processing of the RFID thread as will be described below. The example carrying structure 132 typically does not significantly affect the structural properties of any rope structure incorporating the third example RFID thread 130.

In the third example RFID thread 130, the intervals between adjacent RFID systems 134 are constant, but these intervals can be varied. The RFID systems 134 may all be the same, or one or more types of RFID systems may be used to form the third example RFID thread 130. As an example embodiment of the third example RFID thread 130 including different spacing intervals between and different types of RFID systems, a first type of RFID system 134 may be located at each end of the RFID thread 130, and a second type of RFID system may be arranged at equally spaced intervals between the ends of the RFID thread 130.

The example jacket structure 136 is a continuous member that extends along at least a portion of the length of the third example RFID thread 130 and at least partly encloses the carrying structure 132 and RFID systems 134. The example jacket structure 136 may take a variety of forms, but typically will be made of material configured to protect one or both of the carrying structure 132 and the RFID systems 134. As examples, the example jacket structure 136 may enhance resistance to abrasion of the carrying structure 132 and/or RFID systems 134 and may prevent or inhibit water from reaching the RFID systems 134.

Each of the example spacer portions 138 is arranged inside of an annular jacket chamber defined by the jacket structure 136 and between at least two adjacent RFID systems 134. The example spacer portions 138 may take a variety of forms, but typically will be made of material selected and configured to engage the jacket structure to form a seal within the jacket chamber between adjacent RFID systems 134. With appropriate selection of the materials forming the jacket structure 136 and the spacer portions 138, each RFID system 134 may be arranged within a sealed RFID system chamber that prevents water from reaching the RFID system 134 within that sealed RFID chamber. As described above, the RFID systems 134 may not operate properly when submersed in water, and the spacer portions 138 can be configured to prevent water from traveling along the length of the third example RFID thread 130. However, failure of the jacket structure 136 at any location along the third example RFID thread 130 allows water to enter the RFID chamber at the point of failure and reach the RFID system 134 within the failed RFID chamber. Failure of the RFID system 134 within the failed RFID chamber can provide information about the rope structure incorporating the third example RFID thread 130.

FIG. 7 illustrates a first example extrusion system 140 that may be used to form either of the second or third RFID threads 120 and 130. The first example extrusion system 140 comprises an extrusion structure 142 defining a thread inlet portion 150, a filler inlet portion 152, a jacket inlet portion 154, and an outlet portion 156. The thread inlet portion 150 defines a thread inlet opening 160, the filler inlet portion 152 defines a filler inlet opening 162, the jacket inlet portion 154 defines a jacket inlet opening 164, and the outlet portion 156 defines a central outlet opening 166 and an annular outlet opening 168. A central passageway 170 extends from the thread inlet opening 160 to the central outlet opening 166. An annular passageway 172 extends from the filler inlet opening 162 and the annular outlet opening 168. The filler inlet opening 162 is in fluid communication with the central passageway 170 between the thread inlet opening 160 and the central outlet opening 166. The annular passageway 172 is arranged between the thread inlet opening 160 and the annular outlet opening 168.

To form the second example RFID thread 120, the RFID structures 124 are first supported by the carrying structure 122 at desired spacing intervals. The carrying structure 122 is then fed through the thread inlet opening 160 and pulled through the central outlet opening 166 such that the carrying structure 122 is supported within the central passageway 170. Ideally, the carrying structure 122 is held under tension such that the carrying structure 122, and RFID structures 124 supported thereby, are spaced from the walls defining the central passageway 170. The carrying structure 122 is then displaced through the central passageway 170 in the direction shown by Arrow A in FIG. 7 at a desired displacement rate.

While the carrying structure 122 is displaced through the central passageway 170, settable material 180 is injected through the filler inlet opening 162 and jacket material 182 is injected through the jacket inlet opening 164. The settable material 180 and jacket material 182 are both continuously injected at filler and jacket injection rates, respectively, appropriate to form the jacket structure 126 and spacer portion 128. The settable material 180 thus coats the carrying structure 122 and the RFID structures 124 supported thereby, and the jacket material 182 coats the settable material 180 that has been applied to the carrying structure 122 and its supported RFID structures 124.

To form the third example RFID thread 130 using the first example extrusion system 140, the RFID structures 134 are first supported by the carrying structure 132 at desired spacing intervals. The carrying structure 132 is then fed through the thread inlet opening 160 and pulled through the central outlet opening 166 such that the carrying structure 132 is supported within the central passageway 170. Ideally, the carrying structure 132 is held under tension such that the carrying structure 132, and RFID structures 134 supported thereby, are spaced from the walls defining the central passageway 170. The carrying structure 132 is then displaced through the central passageway 170 in the direction shown by Arrow A in FIG. 7 at a desired displacement rate.

While the carrying structure 122 is displaced through the central passageway 170, settable material 180 is periodically injected through the filler inlet opening 162 and jacket material 182 is continuously injected through the jacket inlet opening 164. The settable material 180 and jacket material 182 are both injected at filler and jacket injection rates, respectively, appropriate to form the jacket structure 136 and spacer portions 138. The periodic injection of the settable material 180 is timed such that the settable material 180 coats only a portion of the carrying structure 122 between the RFID structures 124 supported thereby. The solidified jacket material 182 forms the jacket structure 136 in the shape of an elongate hollow structure. The settable material 180 that has been applied to the carrying structure 132 solidifies to form the spacer portions 138 such that the spacer portions 138 engage the inner surface of the jacket structure 136 to define the separate RFID chambers.

FIG. 8 illustrates a fourth example RFID thread 220. The fourth example RFID thread 220 comprises a carrying structure 222, a plurality of RFID systems 224, a jacket structure 226, and a plurality of discrete spacer portions 228. The fourth example RFID thread 220 may be used as part of an RFID rope structure such as the RFID rope structure 50.

The example carrying structure 222 supports the example RFID systems 224 at spaced intervals. The example carrying structure 222 primarily facilitates the handling of the RFID systems 224 during subsequent processing of the RFID thread as will be described below. The example carrying structure 222 typically does not significantly affect the structural properties of any rope structure incorporating the fourth example RFID thread 220.

In the fourth example RFID thread 220, the intervals between adjacent RFID systems 224 are constant, but these intervals can be varied. The RFID systems 224 may all be the same, or one or more types of RFID systems may be used to form the fourth example RFID thread 220. As an example embodiment of the fourth example RFID thread 220 including different spacing intervals between and different types of RFID systems, a first type of RFID system 224 may be located at each end of the RFID thread 220, and a second type of RFID system may be arranged at equally spaced intervals between the ends of the RFID thread 220.

The example jacket structure 226 is a continuous member that extends along at least a portion of the length of the fourth example RFID thread 220 and at least partly encloses the carrying structure 222 and RFID systems 224. The example jacket structure 226 may take a variety of forms, but typically will be made of material configured to protect one or both of the carrying structure 222 and the RFID systems 224. As examples, the example jacket structure 226 may enhance resistance to abrasion of the carrying structure 222 and/or RFID systems 224 and may prevent or inhibit water from reaching the RFID systems 224.

Each of the example spacer portions 228 is arranged inside of an annular jacket chamber defined by the jacket structure 226 and between at least two adjacent RFID systems 224. The example spacer portions 228 may take a variety of forms, but typically will be made of material selected and configured to engage the jacket structure to form a seal within the jacket chamber between adjacent RFID systems 224. With appropriate selection of the materials forming the jacket structure 226 and the spacer portions 228, each RFID system 224 may be arranged within a sealed RFID system chamber that prevents water from reaching the RFID system 224 within that sealed RFID chamber. As described above, the RFID systems 224 may not operate properly when submersed in water, and the spacer portions 228 can be configured to prevent water from traveling along the length of the fourth example RFID thread 220. However, failure of the jacket structure 226 at any location along the fourth example RFID thread 220 allows water to enter the RFID chamber at the point of failure and reach the RFID system 224 within the failed RFID chamber. Failure of the RFID system 224 within the failed RFID chamber can provide information about the rope structure incorporating the fourth example RFID thread 220.

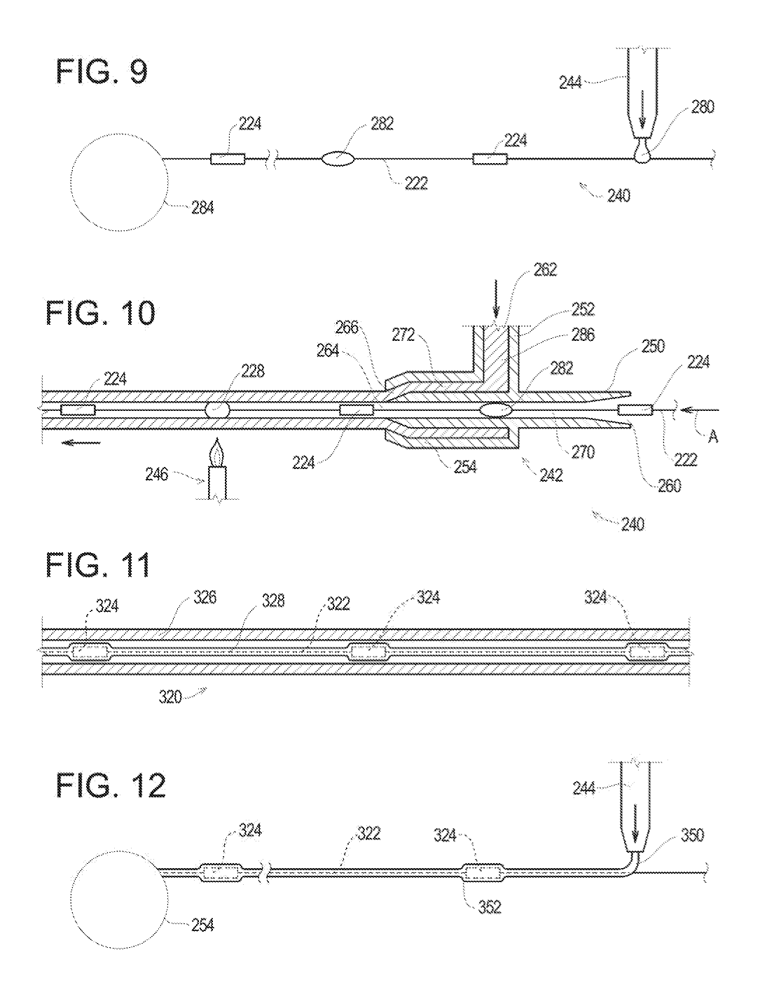

FIGS. 9 and 10 illustrate a second example extrusion system 240 that may be used to form either of the fourth RFID thread 220. The second example extrusion system 240 comprises an extrusion structure 242, a coating system 244, and a heating element 246. The example extrusion structure 242 defines a thread inlet portion 250, a jacket inlet portion 252, and an outlet portion 254. The thread inlet portion 250 defines a thread inlet opening 260, the jacket inlet portion 252 defines a jacket inlet opening 262, and the outlet portion 254 defines a central outlet opening 264 and an annular outlet opening 266. A central passageway 270 extends from the thread inlet opening 260 to the central outlet opening 266. An annular passageway 272 extends from the jacket inlet opening 262 to the annular outlet opening 266. The annular passageway 272 is arranged between the jacket inlet opening 262 and the annular outlet opening 266.

To form the third example RFID thread 220, the RFID structures 224 are first supported by the carrying structure 222 at desired spacing intervals. Before, during, or after the process of supporting the RFID structures 224 on the carrying structure 222, the coating structure 242 applies coating material 280 to the carrying structure 222, and the example coating material 280 then solidifies to form uncured spacing portions 282. At this point, the RFID structures 224 and solidified, uncured spacing portions 282 are sufficiently bonded to the carrying structure to allow the carrying structure 222 to be taken up on an optional reel 284 for storage and/or transfer to another location.

The carrying structure 222 is then fed through the thread inlet opening 260 of the extrusion structure 240 and pulled through the central outlet opening 266 such that the carrying structure 222 is supported within the central passageway 270 as shown in FIG. 10. If the reel 284 is used, the carrying structure 222 is taken from the reel 284 and fed through the thread inlet opening 260. Ideally, the carrying structure 222 is held under tension such that the carrying structure 222, and RFID structures 224 and uncured spacing portions 282 supported thereby, are spaced from the walls defining the central passageway 270. The carrying structure 222 is then unspooled from the reel 284 and displaced through the central passageway 270 in the direction shown by Arrow A in FIG. 10 at a desired displacement rate.

While the carrying structure 222 is displaced through the central passageway 270, jacket material 286 is injected through the jacket inlet opening 264. The jacket material 286 is continuously injected at a jacket injection rate to form the jacket structure 226.

After the jacket structure 226 has been formed around the carrying structure 222, RFID systems 224, and uncured spacer portions 282, the heating element 246 applies sufficient heat to cure the uncured spacer portions 282 and form the spacer portions 228. At this point, the spacer portions 282 are bonded to an interior surface of the jacket structure 226 to define RFID chambers within the jacket chamber defined by the jacket structure 226.

FIG. 11 illustrates a fifth example RFID thread 320. The fifth example RFID thread 320 comprises a carrying structure 322, a plurality of RFID systems 324, a jacket structure 326, and a coating portion 328. The fifth example RFID thread 320 may be used as part of an RFID rope structure such as the RFID rope structure 50.

The example carrying structure 322 supports the example RFID systems 324 at spaced intervals. The example carrying structure 322 primarily facilitates the handling of the RFID systems 324 during subsequent processing of the RFID thread as will be described below. The example carrying structure 322 typically does not significantly affect the structural properties of any rope structure incorporating the fifth example RFID thread 320.

In the fifth example RFID thread 320, the intervals between adjacent RFID systems 324 are constant, but these intervals can be varied. The RFID systems 324 may all be the same, or one or more types of RFID systems may be used to form the fifth example RFID thread 320. As an example embodiment of the fifth example RFID thread 320 including different spacing intervals between and different types of RFID systems, a first type of RFID system 324 may be located at each end of the RFID thread 320, and a second type of RFID system may be arranged at equally spaced intervals between the ends of the RFID thread 320.

The example jacket structure 326 is a continuous member that extends along at least a portion of the length of the fifth example RFID thread 320 and at least partly encloses the carrying structure 322 and RFID systems 324. The example jacket structure 326 may take a variety of forms, but typically will be made of material configured to protect one or both of the carrying structure 322 and the RFID systems 324. As examples, the example jacket structure 326 may enhance resistance to abrasion of the carrying structure 322 and/or RFID systems 324 and may prevent or inhibit water from reaching the RFID systems 324.

The example coating portion 328 is continuous coating arranged inside of an annular jacket chamber defined by the jacket structure 326 and over the carrying structure 322 and the RFID systems 324. The example coating portion 328 may take a variety of forms. With appropriate selection of the materials forming the jacket structure 326 and the coating portion 328, the jacket structure 326 and/or coating portion 328 can be configured to prevent water from reaching the RFID systems 324.

FIG. 12 illustrates that the second example extrusion system 340 may be used to form the fifth example RFID thread 320. Instead of discrete solidified, uncured spacing portions, the coating system 244 forms a continuous uncured coating 350 on the carrying structure 322 and the RFID systems 324. After the continuous, uncured coating 350 solidifies, the carrying structure 322, RFID structures 324, and coating 350 may be taken up on a reel 352 for storage and/or transportation.

To complete manufacture of the third example RFID thread 320, the contents of the reel 384 may be fed into the extrusion system 242 and cured with the heating element 246 as generally shown in FIG. 10. After curing, the continuous, uncured coating 250 may be bonded to at least a portion of the interior surface of the jacket structure 322 and, in particular, at the locations of the RFID structures 224 as shown in FIG. 11.

FIG. 13 illustrates a sixth example RFID thread 420. The sixth example RFID thread 420 comprises a carrying structure 422, a plurality of RFID systems 424, and a jacket structure 426. The example jacket structure 426 defines crimped portions 428. The sixth example RFID thread 420 may be used as part of an RFID rope structure such as the RFID rope structure 50.

The example carrying structure 422 supports the example RFID systems 424 at spaced intervals. The example carrying structure 422 primarily facilitates the handling of the RFID systems 424 during subsequent processing of the RFID thread as will be described below. The example carrying structure 422 typically does not significantly affect the structural properties of any rope structure incorporating the sixth example RFID thread 420.

In the sixth example RFID thread 420, the intervals between adjacent RFID systems 424 are constant, but these intervals can be varied. The RFID systems 424 may all be the same, or one or more types of RFID systems may be used to form the sixth example RFID thread 420. As an example embodiment of the sixth example RFID thread 420 including different spacing intervals between and different types of RFID systems, a first type of RFID system 424 may be located at each end of the RFID thread 420, and a second type of RFID system may be arranged at equally spaced intervals between the ends of the RFID thread 420.

The example jacket structure 426 is a continuous member that extends along at least a portion of the length of the sixth example RFID thread 420 and defines a jacket chamber at least partly enclosing the carrying structure 422 and RFID systems 424. The example jacket structure 426 may take a variety of forms, but typically will be made of material configured to protect one or both of the carrying structure 422 and the RFID systems 424. As examples, the example jacket structure 426 may enhance resistance to abrasion of the carrying structure 422 and/or RFID systems 424. The example jacket member 426 may further prevent or inhibit water from reaching the RFID systems 424.

The example crimped portions 428 are formed between each of the RFID systems 424 to define RFID chambers within the jacket chamber defined by the jacket structure 426. At each crimped portion 428, the jacket structure 426 is deformed such that interior surfaces of the jacket structure 426 are in contact with each other and with the carrying structure 422. The interior surface of the jacket structure 426 may be pressure sensitive such that a bond is formed at the crimped portions 428. Alternatively, heat may be applied to the jacket structure 426 when forming the crimped portions 428 to heat bond the interior surface of the jacket structure 426 to itself at the crimped portions 428. In either case, a fluid-tight seal may be formed around the carrying structure 422 at the crimped portions 428 to seal adjacent RFID chambers from each other.

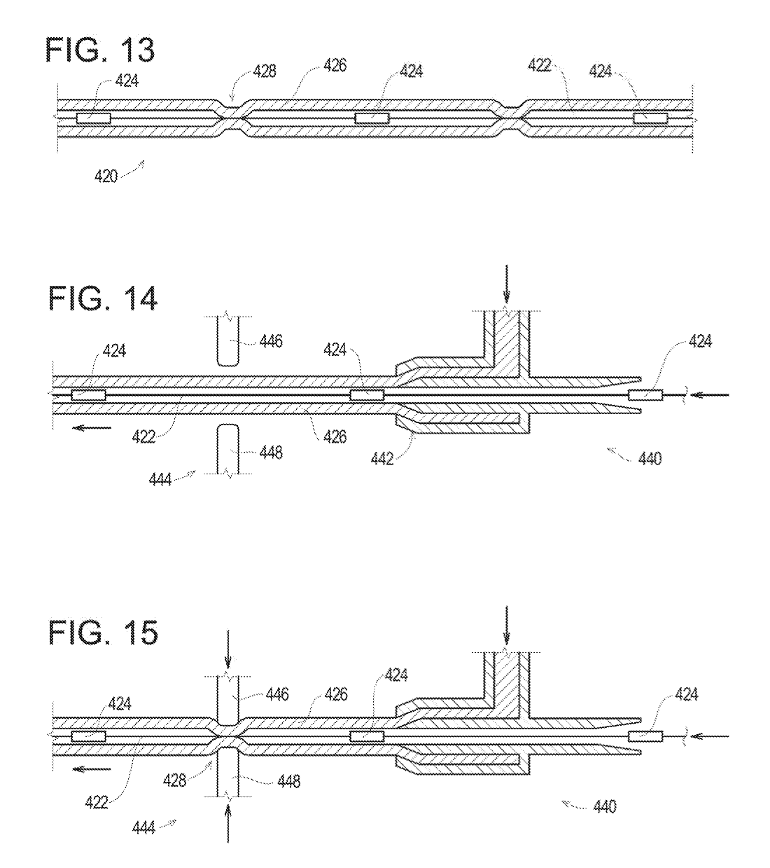

FIGS. 14 and 15 illustrate an example system 440 comprising an injection structure 442 and a crimping system 444. The example injection structure 442 is or may be the same as the example injection structure 242 described above. The crimping system 444 comprises first and second crimping elements 446 and 448 that are driven towards each other to crimp the jacket structure 426. The first and second crimping elements may further be heated such that heat is applied to the jacket structure 426 when the crimping elements 446 and 448 are in contact with the crimped portions 428.

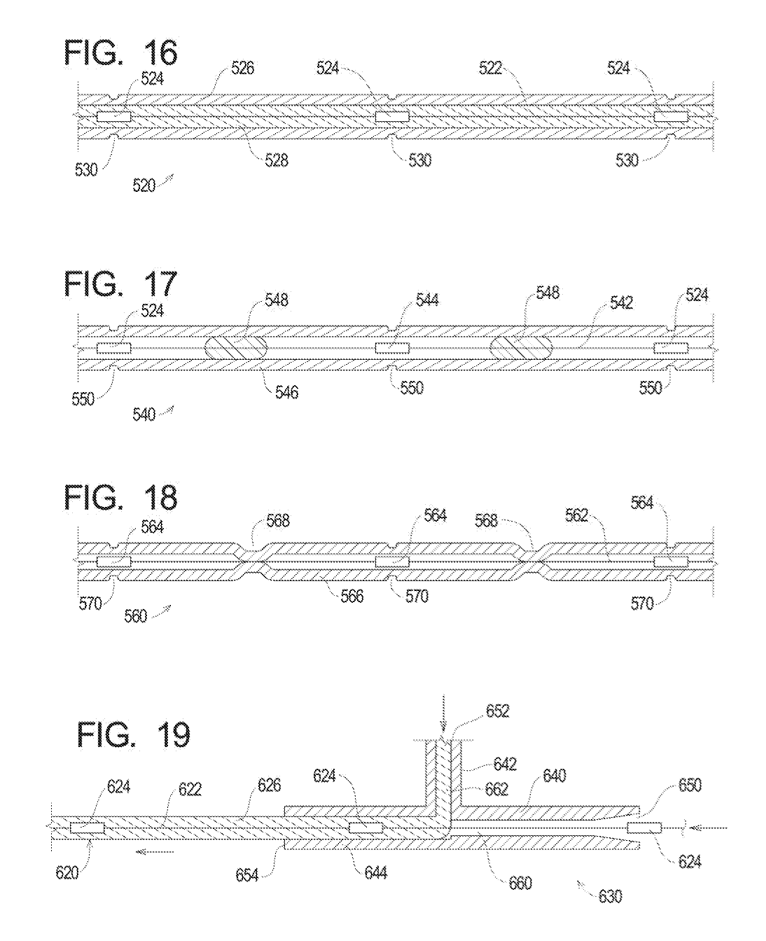

FIG. 16 depicts a seventh example RFID thread 520. The seventh example RFID thread 520 comprises a carrying structure 522, a plurality of RFID systems 524, a jacket structure 526, and a spacer portion 528. The example jacket structure 526 defines a plurality of scored portions 530. The example scored locations 530 extend completely around the outer surface of the jacket structure 526, but only part of the outer surface of the jacket structure 526 may be scored. The scored portions 530 are arranged at predetermined locations to control failure of the seventh example RFID thread 520. In particular, when subjected to tension loads or abrasion beyond a predetermined limit, the jacket structure 526 will fail at the scored portions 530. The example scored portions 530 are arranged adjacent to each of the RFID systems 524 but may be arranged at other locations in addition or instead depending on the intended use of the seventh RFID thread 520. The seventh example RFID thread 520 is or may be similar to the second example RFID thread 120 and may be fabricated in a similar manner. The seventh example RFID thread 520 may be used as part of an RFID rope structure such as the RFID rope structure 50.

FIG. 17 depicts an eighth example RFID thread 540. The eighth example RFID thread 540 comprises a carrying structure 542, a plurality of RFID systems 544, a jacket structure 546, and a plurality of spacer portions 548. The example jacket structure 546 defines a plurality of scored portions 550. The example scored locations 550 extend completely around the outer surface of the jacket structure 546, but only part of the outer surface of the jacket structure 546 may be scored. The scored portions 550 are arranged at predetermined locations to control failure of the eighth example RFID thread 540. In particular, when subjected to tension loads or abrasion beyond a predetermined limit, the jacket structure 546 will fail at the scored portions 550. The example scored portions 550 are arranged adjacent to each of the RFID chambers defined between the spacer portions 548 but may be arranged at other locations in addition or instead depending on the intended use of the seventh RFID thread 540. The eighth example RFID thread 540 is or may be similar to the third example RFID thread 130 and may be fabricated in a similar manner. The eighth example RFID thread 540 may be used as part of an RFID rope structure such as the RFID rope structure 50.

FIG. 18 depicts a ninth example RFID thread 560. The ninth example RFID thread 560 comprises a carrying structure 562, a plurality of RFID systems 564, and a jacket structure 566. The example jacket structure 566 defines a plurality of crimped portions 568. The example jacket structure 566 defines a plurality of scored portions 570. The example scored locations 570 extend completely around the outer surface of the jacket structure 566, but only part of the outer surface of the jacket structure 566 may be scored. The scored portions 570 are arranged at predetermined locations to control failure of the ninth example RFID thread 560. In particular, when subjected to tension loads or abrasion beyond a predetermined limit, the jacket structure 566 will fail at the scored portions 570. The example scored portions 570 are arranged adjacent to each of the RFID chambers defined between the spacer portions 568 but may be arranged at other locations in addition or instead depending on the intended use of the seventh RFID thread 560. The ninth example RFID thread 560 is or may be similar to the sixth example RFID thread 420 and may be fabricated in a similar manner. The ninth example RFID thread 560 may be used as part of an RFID rope structure such as the RFID rope structure 50.

FIG. 19 depicts a tenth example RFID thread 620. The tenth example RFID thread 620 comprises a carrying structure 622, a plurality of RFID systems 624, and a jacket structure 626. The tenth example RFID thread 620 may be used as part of an RFID rope structure such as the RFID rope structure 50.

FIG. 19 further shows that the tenth example RFID thread 620 may be fabricated with an extrusion structure 630 defining thread inlet portion 640, a jacket inlet portion 642, and an outlet portion 644. The thread inlet portion 640 defines a thread inlet 650, the jacket inlet portion 642 defines a jacket material inlet 652, and the outlet portion 644 defines an outlet opening 654. A main passageway 660 extends from the thread inlet 650 to the outlet opening 654, and the jacket material inlet 654 is in fluid communications with the main passageway at a point between the thread inlet 650 to the outlet opening 654.

The carrying structure 622 supports the RFID systems 624 at spaced locations. With the carrying structure 622 extending through the thread inlet opening 650 and the outlet opening 654, jacket material 662 is forced through the jacket material inlet 652 and into the main passageway 660 such that the jacket structure 626 adheres to the carrying structure 622 and RFID systems 624.

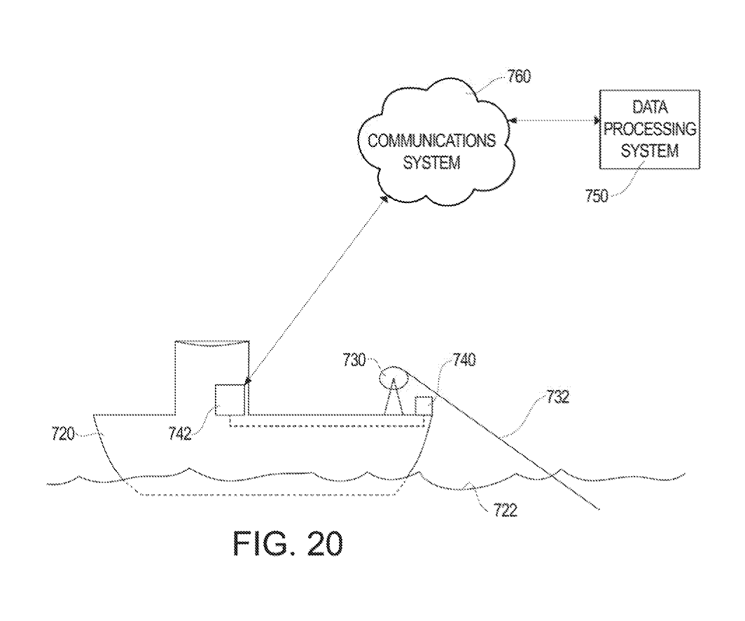

Referring now to FIG. 20, depicted therein is a vessel 720 in water 722. The vessel 720 supports a reel 730 of RFID rope structure 732. The RFID rope structure 732 may be any rope structure incorporating any of the RFID threads described herein. The example vessel 720 also supports an RFID reader 740 and a vessel computing system 742. The RFID reader 740 is located adjacent to the point at which the RFID rope structure 732 is feed from the vessel 720. The vessel computing system 742 is in data communication (e.g., wired or wireless) with the RFID reader 740. The vessel computing system 742 is further in data communication with a data processing center 750 through a communications system 760. The example communications system 760 may include one or more of a satellite communications system, a cellular communications system, the Internet, a telephony communications system, and a coaxial cable communications system.

As the RFID rope structure 732 is played out from the reel 730, the RFID reader 740 reads the RFID systems (not visible in FIG. 20) of an RFID thread (not visible in FIG. 20) supported by the RFID rope structure 732 and transmits RFID system data to the vessel computing system 742 and/or to the data processing system 750 through the vessel computing system 742 and communications system 760.

Based on the RFID data generated by the RFID reader 740, the amount of rope played out, the status of the rope, and other rope characteristics can be calculated or generated by the vessel computing system 742 and/or the data processing system 750. For example, if an RFID system forming part of the RFID rope structure 732 does not respond, it may be determined that the rope has been subjected to abrasion or excessive tension loads.

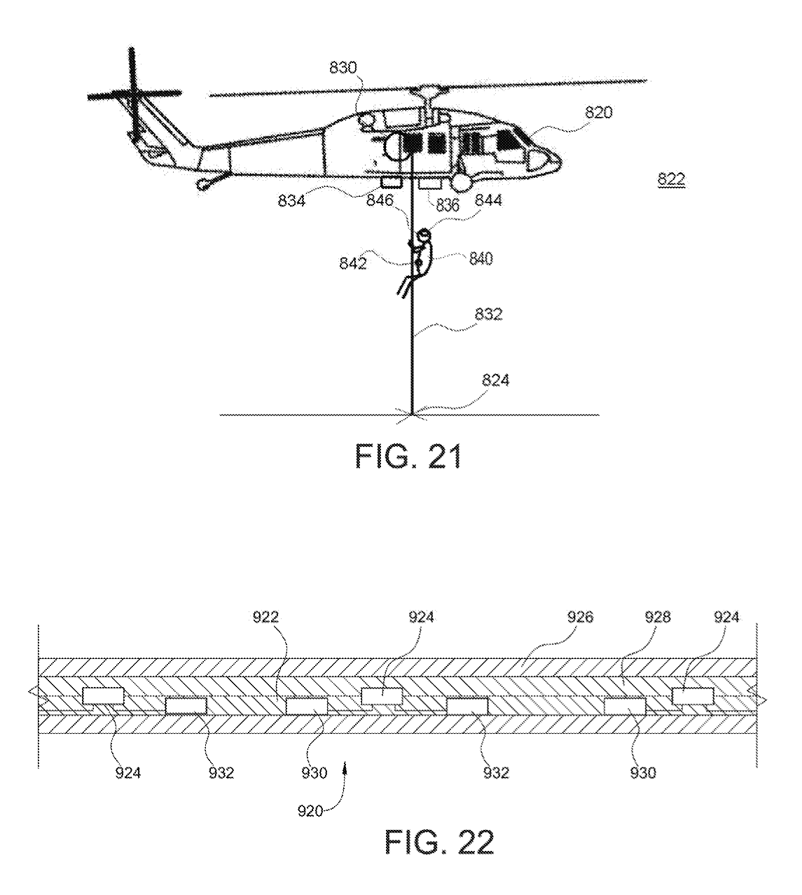

Referring now to FIG. 21, depicted therein is a helicopter 820 hovering in the air 822 above a drop target 824. The helicopter 820 supports a reel 830 of RFID rope structure 832. The RFID rope structure 832 may be any rope structure incorporating any of the RFID threads described herein. The example helicopter 820 also optionally supports an onboard computing system 834 and an onboard onboard RFID reader 836.

Rappelling down from the helicopter 820 to the drop target 824 on the example RFID rope structure 832 is a user 840. The user 840 carries a user RFID reader 842 and a wearable processor 844. The example wearable processor 844 may be connected to or incorporated into a helmet 846 having a user interface system (not visible in FIG. 21) such as a display, audio speaker, or the like. The user 840 wearing the helmet 846 may thus receive communications from the wearable processor 844 through the user interface system connected to the wearable processor 844 while rappelling down from the helicopter 820.

The user RFID reader 842 is located adjacent to the RFID rope structure 832 supporting the user 840. The wearable processor 844 is in data communication (e.g., wired or wireless) with the user RFID reader 842. The example optional onboard computing system 834 may be also be in data communication with the wearable processor 844. In this case, the user 840 may further receive communications from the onboard computing system 834 through the user interface connected to the wearable processor 844.

As the user 840 rappels down along the RFID rope structure 832, the user RFID reader 842 reads the RFID systems (not visible in FIG. 20) of an RFID thread (not visible in FIG. 20) supported by the RFID rope structure 832 and transmits RFID system data to the wearable processor 844 through the onboard computing system 834. In turn, RFID system data may be transmitted from the wearable processor 844 to the onboard computing system 834. Based on the RFID data generated by the user RFID reader 842, the wearable processor 844 and/or the onboard computing system 834 can calculate or generate rope characteristics such as the distance along the RFID rope structure 832 along which the user 840 has moved and a status of one or more characteristics of the RFID rope structure 832. Based on this information, the user 840 (or components of the rappelling system (not shown)) may control rappelling factors such as the rate of descent and stop location.

If the onboard processor 834 and the onboard onboard RFID reader 836 are used, the onboard onboard RFID reader 836 is located adjacent to the RFID rope structure 832 adjacent to the reel 830, and the onboard processor 834 is in data communication (e.g., wired or wireless) with the onboard user RFID reader 842. As the RFID rope structure 832 is played out from the reel 830, the onboard RFID reader 836 reads the RFID systems (not visible in FIG. 20) of an RFID thread (not visible in FIG. 20) supported by the RFID rope structure 832 and transmits RFID system data to the onboard computing system 834. The onboard computing system 834 may in turn communicated the RFID system data to the wearable processor 844. Based on the RFID data generated by the user RFID reader 842, the wearable processor 844 and/or the onboard computing system 834 can calculate or generate rope characteristics such as the amount of rope played out and the status of the rope.

At least some of these rope characteristics, and in particular the amount of RFID rope structure 832 played out and/or distance that the user 840 has moved along the RFID rope structure 832, are communicated to the user 840 through the user interface system connected to or forming a part of the wearable processor 844. Based on this information, the user 840 (or components of the rappelling system (not shown)) may control rappelling factors such as the rate of descent and stop location.

While the example RFID rope structure 832 is depicted in FIG. 21 in the context of a helicopter 820 and a drop target 824, the system depicted in FIG. 21 may be configured to accommodate any structure, fixed or otherwise, from which a user may rappel down to a drop target. For example, the reel 830, rope structure 832, and onboard computing system 834 may be supported relative to a building or other manmade structure, an earthen structure, or the like.

Turning now to FIG. 22, a tenth example RFID thread 920 of the present invention is depicted therein. The second example RFID thread 920 comprises a carrying structure 922, a plurality of RFID systems 924, a jacket structure 926, and a spacer portion 928. The example RFID thread 920 may be used as part of an RFID rope structure such as the RFID rope structure 50. The tenth example RFID thread 920 further comprises first and second sensors 940 and 942 attached to each of the RFID systems 924. The sensors 940 and 942 are capable of sensing environmental conditions such as temperature and pressure and communicating sensor data representative of these environmental conditions to the RFID systems 924 to which the sensors 940 and 942 are connected. Accordingly, the RFID system(s) may further transmit stored or instantaneous sensor data obtained from the sensors 940 and 942 to an RFID reader capable of reading data from the RFID system(s) 924.

The example carrying structure 922 supports the example RFID systems 924 and associated sensor or sensors 940 and 942 at spaced intervals. The example carrying structure 922 primarily facilitates the handling of the RFID systems 924 during subsequent processing of the RFID thread as will be described below. The example carrying structure 922 typically does not significantly affect the structural properties of any rope structure incorporating the second example RFID thread 920.

In the second example RFID thread, the intervals between adjacent RFID systems 924 and associated sensors 940 and 942 are constant, but these intervals can be varied. The RFID systems 924 and sensors 940 and 942 may all be the same, or one or more types of RFID systems 924 and/or sensors 940 and 942 may be used to form the second example RFID thread 920. As an example embodiment of the second example RFID thread 920 including different spacing intervals between and different types of RFID systems, a first type of RFID system 924 may be located at each end of the RFID thread 920, and a second type of RFID system may be arranged at equally spaced intervals between the ends of the RFID thread 920.

The example jacket structure 926 is a continuous member that extends along at least a portion of the length of the second example RFID thread 920 and at least partly encloses the carrying structure 922 and RFID systems 924. The example jacket structure 926 may take a variety of forms, but typically will be made of material configured to protect one or both of the carrying structure 922 and the RFID systems 924. As examples, the example jacket structure 926 may enhance resistance to abrasion of the carrying structure 922 and/or RFID systems 924 and may prevent or inhibit water from reaching the RFID systems 924.

The example spacer portion 928 is arranged outside of the carrying structure 922 and RFID systems 924 and inside of an annular jacket chamber defined by the jacket structure 926 and extends the entire length of the second example RFID thread 920. The example spacer portion 928 may take a variety of forms, but typically will be made of material selected and configured to engage the jacket structure to form a seal within the jacket chamber and around one or both of the carrying structure 922 and the RFID systems 924. With appropriate selection of the materials forming the jacket structure 926 and the spacer portion 928, water may be prevented from reaching one or both of the carrying structure 922 and the RFID systems 924. The RFID systems 924 in particular may not operate properly when submersed in water. For example, if the example RFID system 32 depicted in FIG. 9 is used as the RFID systems 924, water may contact the first and second antennas 42 and 44 and prevent proper operation of the example RFID system 32.

Any of the example RFID threads described herein may be modified to include one or more sensors such as the sensors 940 and/or 942 described herein.

What is claimed is:

1. An RFID rope structure comprising:
an RFID thread comprising a carrying structure and a plurality of RFID systems supported by the carrying structure; and
a plurality of rope elements combined to define a reference axis; wherein
the RFID thread is supported by the rope elements such that each of the RFID systems is arranged at a predetermined location along the rope reference axis.

2. An RFID rope structure as recited in claim 1, in which:
the rope elements are combined to form at least one strand; and
the RFID thread is incorporated into the at least one strand.

3. An RFID rope structure as recited in claim 1, in which:
the rope elements are combined to form a plurality of strands; and
the RFID thread is incorporated into the at least one of the plurality of strands.

4. An RFID rope structure as recited in claim 1, in which:
the combined rope elements define a rope length;
the RFID thread defines a thread length; and
the RFID thread length is greater than the rope length.

5. An RFID rope structure as recited in claim 1, in which the RFID systems are arranged at evenly spaced locations along the rope reference axis.

6. An RFID rope structure as recited in claim 1, further comprising a jacket structure that extends along at least a portion of a length of the RFID thread.

7. An RFID rope structure as recited in claim 6, further comprising a spacer structure that extends along at least a portion of the length of the RFID thread within the jacket structure.

8. An RFID rope structure as recited in claim 6, further comprising a plurality of discrete spacer structures arranged along at least a portion of the length of the RFID thread within the jacket structure.

9. An RFID rope structure as recited in claim 8, in which the plurality of discrete spacer structures defines at least one RFID chamber within a jacket chamber defined by the jacket structure.

10. An RFID rope structure as recited in claim 6, further comprising a plurality of crimped portions of the jacket structure, where the plurality of crimped portions define at least one RFID chamber within a jacket chamber defined by the jacket structure.

11. An RFID rope structure as recited in claim 6, further comprising a plurality of scored portions of the jacket structure, where each of the plurality of scored portions is formed at a predetermined location with respect to at least one of the RFID systems.

12. An RFID rope structure as recited in claim 9, further comprising a plurality of scored portions of the jacket structure, where each of the plurality of scored portions is formed at a predetermined location with respect to the at least one RFID chamber.

13. An RFID rope structure as recited in claim 1, further comprising at least one sensor operatively connected to at least one of the RFID systems.

14. An RFID rope structure as recited in claim 13, in which the at least one sensor comprises at least one of a temperature sensor and a pressure sensor.

15. A rope system comprising:
an RFID rope structure comprising an RFID thread and a plurality of rope elements;
an RFID reader arranged at a desired location relative to the RFID rope structure; and
a processor for determining at least one characteristic of the RFID rope structure as at least a portion of the RFID rope structure moves past the RFID reader.

16. A rope system as recited in claim 15, in which the RFID reader is fixed relative to a structure to determine an amount of rope played out relative to the structure.

17. A rope system as recited in claim 15, in which the RFID reader is fixed relative to a user moving relative to the RFID rope structure to determine a distance that the user moves relative to a reference axis defined by the RFID rope structure.

18. An RFID rope structure comprising:
an RFID thread comprising a carrying structure and a plurality of RFID systems supported by the carrying structure; and
a plurality of rope strands combined to define a reference axis; wherein
the RFID thread is supported by at least one of the rope strands such that each of the RFID systems is arranged at a predetermined location along the rope reference axis.

19. An RFID rope structure as recited in claim 18, in which:
the combined rope strands define a rope length;
the RFID thread defines a thread length; and
the RFID thread length is greater than the rope length.

20. An RFID rope structure as recited in claim 19, further comprising a jacket structure that extends along at least a portion of a length of the RFID thread.
